(19) United States
(12) Patent Application Publication
(10) Pub. No.: US 2003/0096599 A1
(43) Pub. Date: May 22, 2003

(54) Message distribution system and method for selecting the device where a recipient is most likelly to recognize a message

(75) Inventor: Katsuhito Takatsuki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/287,697

(22) Filed: Nov. 5, 2002

(30) Foreign Application Priority Data
Nov. 20, 2001 (JP) 354650/2001

(51) Int. Cl. H04M 11/10; H04Q 7/20

(52) U.S. Cl. 455/412; 455/466

(57) ABSTRACT

A message distribution system transmits a message to one of a recipient's plural communication terminals having the largest possibility that the recipient immediately recognizes the message even though the sender does not know the current location of the recipient. The system includes a receiving unit which receives a message from a sender's terminal, a storage unit which records access history information of each of recipient's terminals, a destination selection unit which selects the one of the recipient's terminal based on information stored in the storage unit, and a transmission unit which transmits the message to the selected one of the recipient's terminals.

### BACKGROUND OF THE INVENTION

The present invention relates to a message distribution system and method, and more specifically to a message distribution system and a method of distributing a message to one of a plurality of communication devices operated by a recipient of the message.

Recently, there have been an increasing number of users having two or more communication devices, such as a mobile telephone, a Personal Digital Assistant (PDA), a notebook PC and a desktop PC. In addition, there are several message transmission/reception systems, such as a mobile telephone mail system, an Internet mail system, an instant message system, etc.

In a conventional message distribution system under the above-mentioned environment, the user receives and transmits messages using the message transmission/reception system suited to the communication device.

It should be noted that the message transmission/reception systems differ in address information such as an Email address for the Internet mail system, an Email address for the mobile telephone mail system, an ID for the instant message system, etc., even though a message is being transmitted to a single user. Therefore, when a sender transmits a message requiring immediacy to a recipient, the sender must guess the message transmission/reception system in which the message will be read the earliest by the recipient, and transmits the message using the selected message transmission/reception system.

For example, in the event that the sender guesses that the recipient is out of his/her office and only has a mobile phone, the sender transmits a message to an Email address corresponding to the mobile phone. In the event that the sender guesses that the recipient is in his/her office using a PC, the sender transmits an instant message.

However, the conventional message distribution system is inconvenient, because when the sender transmits a message requiring immediacy, it is uncertain that the recipient will immediately see the message unless the current location of the recipient is known. Additionally, different transmission/reception systems demand different sending operations.

### SUMMARY OF THE INVENTION

The present invention has an object to provide a message distribution system and method capable of transmitting a message to the one of recipient's communication devices having the largest possibility that the recipient immediately recognizes the message, even though the sender does not know the current location of the recipient.

According to one aspect of the present invention, a message distribution system includes a receiving unit which receives a message from a sender's terminal via a communication network, a storage unit which records access history information of each of recipient's terminals indicating when each of the recipient's terminals accesses the communication network, a destination selection unit which determines the one of the recipient's terminals where the recipient is most likely to recognize the message based on the information stored in the storage unit, and a transmission unit which transmits the message to the recipient's terminal selected by the destination selection unit.

According to another aspect of the present invention, a message distribution method includes a first step of receiving a message from a sender's terminal by a receiving unit via a communication network, a second step of determining the one of recipient's terminals where the recipient is most likely to recognize the message based on historical information for each of the recipient's terminals indicating times when each of the recipient's terminals accesses the communication network, and a third step of transmitting the message to the recipient's terminal determined by the destination selection unit.

### BRIEF DESCRIPTION OF THE DRAWINGS

These and other objects, features and advantages of the invention will become more apparent from the following detailed description when taken in conjunction with the accompanying drawings, in which:

FIG. 1 shows a block diagram of a message distribution system according to an embodiment of the present invention;

FIG. 2 shows a storage format example of a user information table; and

FIG. 3 shows a flow of the process by the message distribution system.

### DESCRIPTION OF THE PREFERRED EMBODIMENTS

The present invention will now be explained in detail below in reference to the accompanying drawings.

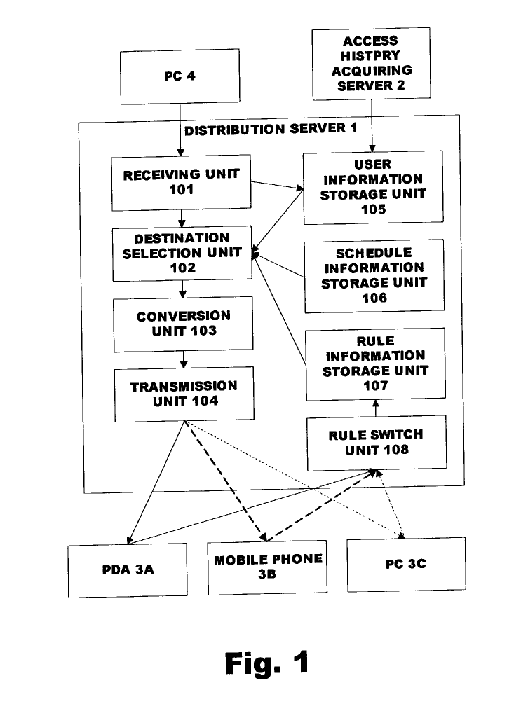

Referring to FIG. 1, a message distribution system includes a distribution server 1, an access history acquiring server 2, a plurality of communication devices of a recipient A such as a PDA 3A, a mobile phone 3B and a PC 3C, and a PC 4 of a sender.

The PDA 3A uses an instant message system as a main communication system. The mobile phone 3B uses mobile telephone mail system as a main communication system. The PC 3C uses an Internet mail system as a main communication system.

The distribution server 1 transmits a message to the one of the recipient's communication devices, having the largest possibility that the recipient immediately recognizes the message. A message is “recognized” when the recipient is aware that a message has been received and can be opened. Preferably, the communication device alerts the recipient that the message has been received.

The distribution server 1, the access history acquiring server 2, the PDA 3A, the mobile phone 3B, the PC 3C and the PC 4 respectively include an information processing unit (not shown), a storage unit (not shown), and a communications unit (not shown) as hardware. The storage unit stores a program and various types of data. The information processing unit controls its own device using the program stored in the storage unit. The communications unit communicates with other devices under the control of the information processing unit.

According to the program stored in the storage unit, the distribution server 1 logically includes a receiving unit 101, a destination selection unit 102, a conversion unit 103, a transmission unit 104, a user information storage unit 105, a user schedule information storage unit 106, a rule information storage unit 107 and a rule switch unit 108.

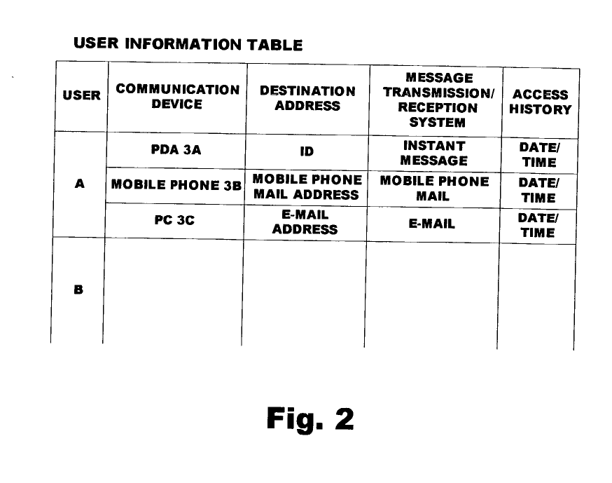

The user information storage unit 105 stores a user information table shown in FIG. 2. Referring to FIG. 2, in the user information table, communication devices held by a user, and addresses, message transmitting/receiving systems and access histories corresponding to the terminals are recorded for every user.

The user schedule information storage unit 106 stores the schedule information of each user. The schedule information can be registered in advance by each user.

The rule information storage unit 107 stores information about the distribution rules. The rule information can be predetermined by each user, can be set as an initial value, and can be selected in advance by a user from among several distribution rules set as initial values.

The access history acquiring server 2 monitors any access to a communication network, for example, browsing the Internet, from the PDA3A, the mobile phone 3B, the PC 3C and the PC 4. If these communication devises access the communication network via the access history access server 2, the access history acquiring server 2 updates the record of the access history in the user information table (shown in FIG. 2). The access history acquiring server 2 may be a proxy server, if the distribution server 1 is a server for connection to an external network such as the Internet. It may be available that the communication devices have a resident program for periodically transmitting the use state to the access history acquiring server 2.

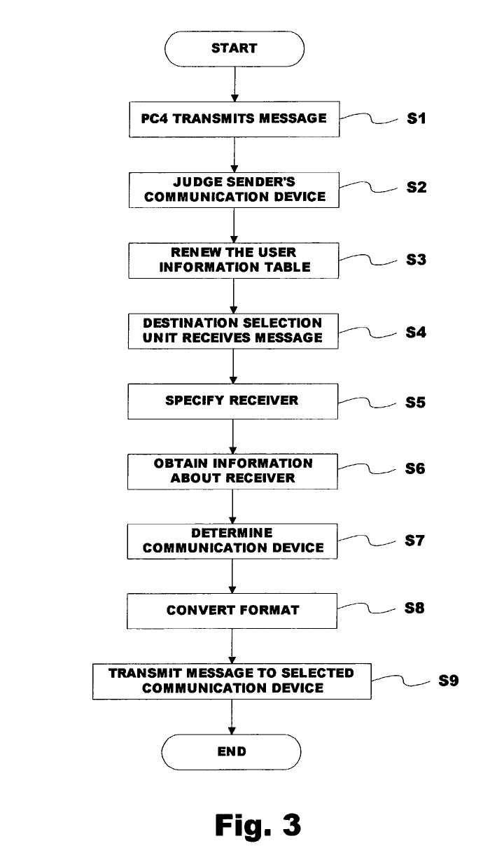

Referring to FIG. 3, in operation, when the sender transmits a message to a recipient A (FIG. 2), the PC4 transmits a message containing destination information to the distribution server 1 via a communication network (Step S1), and the receiving unit 101 receives the message. The destination information is not limited so long as the destination information identifies the recipient A. Of course, address information recorded in the user information table is available as the destination information.

Then, the receiving unit 101 judges the sender's terminal (PC4) by the used message transmitting/receiving system (step S2) and updates the access history of the terminal recorded in the user information table (step S3). At the same time, the receiving unit 101 transmits the message to the destination selection unit 102.

Then the destination selection unit 102 receives the message (step S4). The destination selection unit 102 specifies recipient A according to the destination information contained in the message and the user information table (step S5).

Then, the destination selection unit 102 obtains the information about recipient A as follows (step S6).

The information about the current and the immediately preceding states of the use of the communication devices (the PDA 3A, the mobile phone 3B and the PC 3C) of recipient A is obtained as an access history from the user information table.

The current, preceding, and subsequent schedule information about recipient A is obtained from the user schedule information storage unit 106.

The rule information about the distribution of a message to the communication terminals of recipient A is obtained from the rule information storage unit 107.

According to each piece of the obtained information about recipient A, the destination selection unit 102 determines the one of the communication devices of recipient A on which the recipient A is most probably going to recognize the message first (step S7), and determines the optimum message transmission/reception system for the specified communication device using the user information table and the rule information. The determination can be based on recent information, such as which one of the recipient's communication devices was operated most recently, or based on an analysis of past actions, such as the knowledge that the recipient has used his home computer from 8 PM to 10 PM for five of the last seven days.

In more detail, the destination selection unit 102 first obtains an access history in the user information table about recipient A. For example, assume that there is the information that ‘PDA 3A tried access 6 minutes ago’.

Also assume that the schedule information about recipient A is obtained from the user schedule information storage unit 106. For example, assume that there is the information that ‘a meeting is held 20 minutes from now at the place B outside the office of recipient A’.

Furthermore, the rule information for recipient A is obtained from the rule information storage unit 107 that includes various rules for communicating such as

(1) When a communication device is connected within one minute, a message is transmitted to the communication device.

(2) When an appointment is planned outside the office within 30 minutes, a message is transmitted to the mobile telephone 3B.

(3) The prioritized transmission/reception system to the PDA 3A is an instant message system.

(4) The prioritized transmission/reception system to the mobile phone 3B is a mail system for mobile system.

(5) Normally, an instant message is transmitted to the PDA 3A.

The above listed rule information can be changes by a user and can be assigned priorities.

When the destination selection unit 102 selects a communication device according to the above mentioned information, the mobile telephone 3B is selected as the destination of a message according to the rule (2) and schedule information because the rule (1) does not include a corresponding communication device. In addition, according to the rule (4), the mail system for mobile phone is determined as a transmission/reception system.

The rule information is individually set for each user in advance.

For example, the following rules also can be set.

(1) If there is a communication device set within 5 minutes by the access history of the user information table, the communication device is selected as a destination of a message.

(2) If there is a meeting planned outside the office within 30 minutes in the schedule information, there is a strong possibility that the recipient is on the go, the message is transmitted to the mobile telephone terminal 3B by mobile telephone mail.

(3) When the specified communication device is the PDA 3B or the PC 3C, the transmission/reception system can be an instant message system.

(4) When the specified communication device is a mobile telephone 3B, the transmission/reception system can be a mobile telephone mail system.

After determination of a communication terminal by the destination selection unit 102, the destination selection unit 102 transmits the message, and address information and a transmission/reception system corresponding to the determined communication device.

The conversion unit 103 converts a format of the message into a format which suits to transmission/reception system determined by the destination selection unit 102 (step S8).

For example, when there is a terminal dependent character code in the selected communication device, a conversion is performed.

When a transmission/reception system is limited in data character number, then the message is divided by the conversion unit 103. Or, the conversion unit 103 generates an HTML page designated by a URL and viewable by browser, and transmits information of the URL to the communication device. The process is not limited to this example.

The transmission unit 104 transmits the message converted by the conversion unit 103 to the selected communication device via the communication network (step S9).

The rule switch unit 108 accepts a request to change rules stored in the rule information storage unit 107 from any of the communication devices. The user performs the process of changing the predetermined rule information to enable a dynamic change of distribution rules. The change of rules may be performed with a valid/invalid switch, a priority switch, etc.

In more detail, upon receipt of a request to switch rules by a communication terminal from the user, the rule switch unit 108 switches the distribution rule of the user stored in the rule information storage unit 107.

For example, the distribution rule of recipient A is:

(1) (invalid) necessarily transmitted as an instant message to the PDA 3A.

(2) (invalid) necessarily transmitted as mail to the mobile telephone 3B.

(3) (valid) transmitted to a communication device if it is connected within 1 minute.

(4) (valid) transmitted to the mobile telephone 3B if there is an appointment outside the office within 30 minutes.

(5) (valid) the priority transmission/reception system to the PDA 3A is an instant message system.

(6) (valid) the priority transmission/reception system to the mobile telephone 3B is a mail system for the mobile phone.

(7) (valid) normally, a message is transmitted to the PDA 3A as an instant message.

Assume that the above listed rule information is stored in the rule information storage unit 107. The numerals assigned to the distribution rules refer to the priority of each rule, and a valid/invalid setting is performed on each rule.

When the PDA 3A transmits to the rule switch unit 110 a request to switch the rule information (1) from invalid to valid, the rule (1) becomes valid. Thus, if the message to recipient A is transmitted from the PC 4 to the distribution server 1 after the rule (1) becomes valid, the rule (1) is prioritized in the selection by the destination selection unit 102 in the distributing processed by the distribution server 1, and all messages are transmitted as instant messages to the receiving terminal 3A (PDA).

As described above, according to the message distribution system according to the present invention, a message can be transmitted to a communication device having the largest possibility that a recipient immediately recognizes the message, even though a sender does not know the current location of the recipient. Moreover, the sender does not need to know address information for each of a plurality of communication devices operated by the recipient. Furthermore, a message can be transmitted to a communication device having the largest possibility of currently recognizing the message by the recipient setting the rule information.

While this invention has been described in conjunction with the preferred embodiment described above, it will now be possible for those skilled in the art to put this invention into practice in various other manners.

What is claimed is:

1. A message distribution system comprising:
a receiving unit which receives a message from a sender's terminal via a communication network;
a storage unit which records access history information for each of plural terminals of a recipient of the message indicating when each of the recipient's terminals have accessed the communication network;
a destination selection unit which selects one of the recipient's terminal by using the access history information stored in said storage unit; and
a transmission unit which transmits the message to the one of recipient's terminals selected by said destination selection unit.

2. The message distribution system of claim 1;
wherein said storage unit further stores rules for selecting one of the recipient's terminals by said destination selection unit.

3. The message distribution system of claim 2;
wherein said storage unit further stores schedule information including schedule information for the recipient.

4. The message distribution system of claim 1 further comprising:
an access history acquiring unit that monitors accesses from the recipients terminals to said communication network and updates said access history information when access occurs.

5. The message distribution system of claim 1 further comprising:
a conversion unit which converts a first format of the message into a second format suited to the one of the recipient's terminals selected by said destination selection unit.

6. A message distribution method comprising:
a first step of receiving a message from a sender's terminal by a receiving unit via a communication network;
a second step of selecting one of a recipient's plural terminals to receive the message based on access history information for each of the recipient's terminals indicating when each of the recipient's terminals accessed the communication network; and
a third step of transmitting the message to the selected one of the recipient's terminal.

7. The message distribution method of claim 6;
wherein said second step is also based on rules for selecting the one of the recipient's terminals.

8. The message distribution method of claim 10;
wherein said second step is also based on the recipient's schedule information.

9. The message distribution method of claim 6 further comprising the step of converting a first format of the message into a second format suited to the selected one of the recipient's terminals.

10. The message distribution method of claim 6 further comprising the step of monitoring access to the communication network and updating the access history information in response thereto.

11. The message distribution method of claim 6 further comprising the step of periodically updating the access history information based on information provided by the recipient's terminals.

12. A device for directing a communication from a sender's transmitting terminal to a recipient having plural different receiving terminal, wherein said server includes,
an evaluation unit that determines a one of the plural different receiving terminals where the recipient is most likely to be made aware of the communication first, based on a history of recipient's use of the plural different receiving terminals, the recipient's schedule, and set of rules for directing the digital communication,
a conversion unit for converting the communication to a form appropriate for the determined one of the plural different receiving terminals, and
a transmitter for sending the converted communication to the selected one of the plural different receiving terminals.
